(19) United States
(12) Patent Application Publication
(10) Pub. No.: US 2007/0050786 A1
(43) Pub. Date: Mar. 1, 2007

(54) Disk clamping apparatus for disk drive

(75) Inventor: Kye Yeon Ryu, Pyeongtaek City (KR)

Correspondence Address: BIRCH STEWART KOLASCH & BIRCH, PO BOX 747, FALLS CHURCH, VA, 22040-0747, US

(73) Assignee: HITACHI-LG DATA STORAGE KOREA, INC., Seoul City (KR)

(21) Appl. No.: 11/508,826

(22) Filed: Aug. 24, 2006

(30) Foreign Application Priority Data
Aug. 26, 2005 (KR) 2005-0079009

(51) Int. Cl. G11B 17/04

(52) U.S. Cl. 720/604

(57) ABSTRACT

Disclosed is a disk clamping apparatus for a disk drive. The disk clamping apparatus includes a turntable that is driven by a spindle motor provided on a pickup base and on which a disk is seated, a clamp coupled with the turntable to fix the disk to the turntable with the disk seated on the turntable, and a frictional member causing the turntable, the clamp and the disk to integrally rotate, and closely contacted on a disk surface opposite to the spindle motor on the basis of the disk. The frictional member is provided on a bottom surface of the clamp and selectively brought into close contact with a top surface of the disk. Thereby, a distance between the disk seated on the turntable and the optical pickup can be accurately set, so that signal recording and reproduction of the disk drive are accurately performed. Further, no scratching occurs even when the disk is brought into contact with the clamp, so that damage to the disk is prevented.

### BACKGROUND OF THE INVENTION

1. Field of the Invention

The present invention relates to a disk drive, and more particularly to a disk clamping apparatus for a disk drive, capable of rotatably clamping the disk on a turntable.

2. Description of the Prior Art

The construction of an ordinary disk drive is illustrated in FIGS. 1 and 2. As illustrated in FIGS. 1 and 2, a main base 1 makes up a framework of the disk drive. The main base 1 is provided in the center thereof with a substantially quadrangular through-hole, in which a pickup base 3 is installed.

The pickup base 3 is supported on the main base 1 through anti-vibrators 5 on a rear end thereof. Each anti-vibrator 5 is made of an elastic material, and supports the pickup base 3 on the main base 1 and simultaneously prevents vibration and noise from being transmitted between the pickup base 3 and the main base 1.

The pickup base 3 is provided with a spindle motor 7 for rotating a disk. The spindle motor 7 is provided at an upper end thereof with a turntable 8, which is rotated by the spindle motor 7 and on which a disk D is seated. The turntable 8 is provided with a circular frictional member 8p, which surrounds the edge of a top surface of the turntable 8. The frictional member 8p is for fixing the disk D between the turntable 8 and a clamp 15 to be described below without sliding. The turntable 8 is provided with an insertion cone 8′, which protrudes from the center of the top surface of the turntable and onto an outer circumferential surface of which a middle through-hole of the disk D is pressed. The insertion cone 8′ is formed at the center thereof with a guide hole 8h.

An optical pickup 9 is installed on the pickup base 3 so as to be guided along guide axles 10. The optical pickup 9 is for irradiating a signal recording surface of the disk D to record a signal or read out a recorded signal, and is driven to move along the guide axles 10 by a sled motor (not shown).

Meanwhile, the pickup base 3 is supported on a lifting base 12 at a front end thereof. Anti-vibrators 5′ are also installed between the lifting base 12 and the pickup base 3, thereby supporting the pickup base 3 on the lifting base 12 and simultaneously preventing transmission of vibration and noise.

The lifting base 12 is provided on opposite rear ends thereof with rotational axles 13, each of which is inserted into the main base 1 and thereby serves as a center of rotation about which a front end of the lifting base 12 is raised and lowered.

Now, a construction of the clamping apparatus adapted to prevent the disk D seated on the turntable 8 from being fluctuated during rotation will be described. It is a clamp 15 that fixes the disk D to the turntable 8. The clamp 15 has the shape of a substantially circular plate, in which a magnet 16 is installed. The clamp 15 is provided on a bottom surface thereof with a guide nose 18, which is inserted into the guide hole 8h of the insertion cone 8′. The circular plate-like clamp 15 is formed with a hook wing 18′, which surrounds an edge of the clamp 15 and is stepped to be located at a position higher than the bottom surface of the clamp 15.

The clamp 15 is disposed in a recess 19′, which is concavely formed in a cabinet 19 forming an external appearance of at least a top surface and opposite sides of the disk drive. The recess 19′ is formed with a top surface of the cabinet 19 depressed, through which the clamp 15 is penetrated. When the clamp 15 is not seated on the turntable 8, the hook wing 18′ is hooked in the recess 19′ and thus supported by the cabinet 19.

In the prior art having the above-described construction, the pickup base 3 is raised at its front end while cooperating with operation where the disk D is loaded into the disk drive by a tray. Therefore, the pickup base 3 moves upward to cause the clamp 15 to be attached to the turntable 8 while seating the disk D, which is transferred to a position corresponding to an upper portion of the turntable 8, on the turntable 8.

In this state, as illustrated in FIG. 2, the clamp 15 fixes the disk D seated on the turntable 8 while being attached to the turntable 8 by magnetic force of the magnet 16, so that the disk D is prevented from slipping on the turntable 8. At this time, the guide nose 18 is inserted into the guide hole 8h, and the clamp 15 is raised together with the turntable 8, so that the hook wing 18′ is not hooked in the recess 19′, as illustrated in FIG. 2.

However, the above-described prior art has the following problems.

A vertical distance between the signal recording surface of the disk D seated on the turntable 8 and the optical pickup 9 moving on the pickup base 3 is very important to record and reproduce the signal. However, the frictional member 8p installed on the turntable 8 has a relatively great dimensional tolerance of thickness and is subjected to frequent deformation, so that dimension management between the disk D and the optical pickup 9 is difficult.

The clamp 15 fixing the disk D on the turntable 8 is generally formed of a metal, so that the clamp 15 is frequently contacted with the disk D while the disk D is loaded and unloaded. In this case, the disk D may be scratched and damaged.

### SUMMARY OF THE INVENTION

Accordingly, the present invention has been made to solve these various problems occurring in the prior art, and an objective of the present invention is to make a precise dimension management between a disk and an optical pickup.

It is another objective of the present invention to prevent scratching caused by contact between a disk and a clamp.

In order to accomplish this objective, there is provided a disk clamping apparatus for a disk drive, including: a turntable that is driven by a spindle motor provided on a pickup base and on which a disk is seated; a clamp coupled with the turntable to fix the disk to the turntable with the disk seated on the turntable; and a frictional member causing the turntable, the clamp and the disk to integrally rotate, and closely contacted on a disk surface opposite to the spindle motor on the basis of the disk.

According to the inventive disk clamping apparatus for a disk drive having this construction, a distance between the disk seated on the turntable and the optical pickup can be accurately set, so that signal recording and reproduction of the disk drive are accurately performed. Further, no scratching occurs even when the disk is brought into contact with the clamp, so that damage to the disk is prevented.

### BRIEF DESCRIPTION OF THE DRAWINGS

The above and other objectives, features and advantages of the present invention will be more apparent from the following detailed description taken in conjunction with the accompanying drawings, in which:

FIG. 1 is a top plan view illustrating a construction of an ordinary disk drive;

FIG. 2 is a cross-sectional view illustrating a disk clamping apparatus for an ordinary disk drive;

FIG. 3 is a partial cross-sectional view illustrating an exemplary embodiment of a disk clamping apparatus for a disk drive according to the present invention; and

FIG. 4 is an operational view illustrating a state where a disk is clamped in an exemplary embodiment of the present invention.

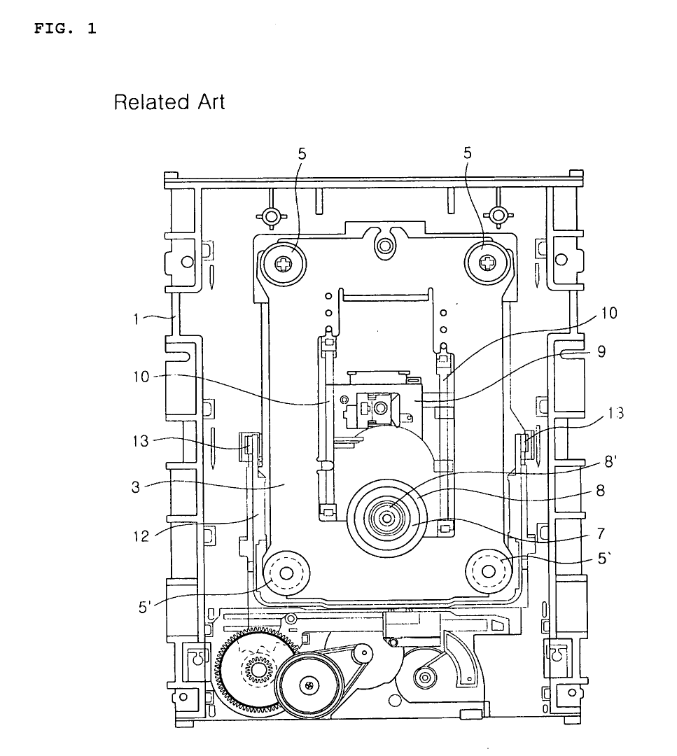

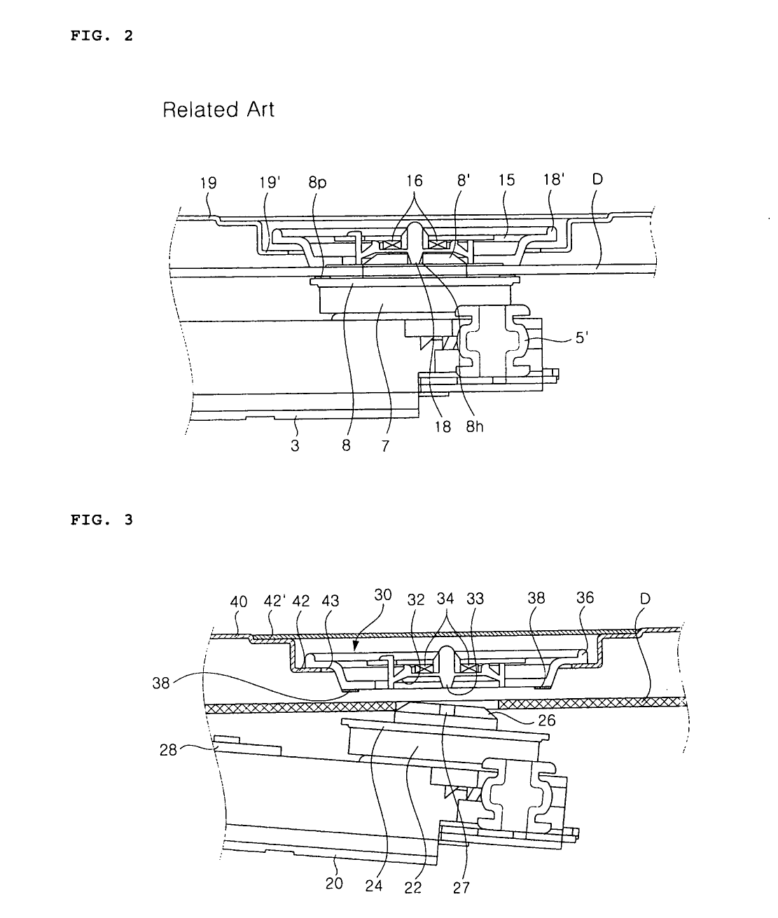

### DETAILED DESCRIPTION OF THE PREFERRED EMBODIMENTS

Hereinafter, exemplary embodiments of a disk clamping apparatus for a disk drive according to the present invention will be described with reference to the accompanying drawings. In the following description, a detailed description of known functions and configurations incorporated herein will be omitted when it may make the subject matter of the present invention unclear.

FIG. 3 is a partial cross-sectional view illustrating an exemplary embodiment of a disk clamping apparatus for a disk drive according to the present invention.

As illustrated in FIG. 3, a spindle motor 22 is installed above a pickup base 20 installed inside the disk drive. The spindle motor 22 provides a driving force for the rotation of a disk D. A turntable 24 is installed to a rotational axle of the spindle motor 22. The disk D is seated on the turntable 24. An insertion cone 26 is provided at the center of the turntable 24, and a guide hole 27 is formed at the center of the insertion cone 26. The pickup base 20 is provided with an optical pickup 28, which can move between positions moving toward and away from the turntable 24 in a radial direction of the disk D. The optical pickup 28 is driven and transferred by a separated driving source, and in the meantime, a signal is recorded on and reproduced from a signal recording surface of the disk D.

A clamp 30 comes into close contact with the disk D seated on the turntable 24 and integrally rotates with the disk. A cone seating recess 32 in which the insertion cone 26 is located is formed on a bottom surface of the clamp 30. A guide nose 33 protrudes in the cone seating recess 32 so as to be directed to the insertion cone 26 of the turntable 24. Here, the cone seating recess 32, the guide nose 33, etc. serve to accurately seat the clamp 30 on the turntable 24, but a construction different from the illustrated embodiment may be employed.

A magnet 34 is provided inside the clamp 30. The magnet 34 is preferably provided at the inside of the clamp 30 which corresponds to the cone seating recess 32. The magnet 34 allows the clamp 30 to be attached to the insertion cone 26 by its magnetic force. To this end, the insertion cone 26 should be made of a magnet itself or include a separate magnet. For reference, it is not essential to provide the magnet 34 inside the clamp 30. In other words, instead of the magnet 34, a weight is disposed inside the clamp 30, or the clamp 30 itself acts as the weight. Thereby, the disk D can be clamped.

The clamp 30 is so constructed that its upper end has a diameter larger than its lower end, and is formed with a hook wing 36 surrounding the upper end of the clamp 30. When the pickup base 20 is relatively lowered and thus the clamp 30 is separated from the turntable 24, the hook wing 36 plays a role so that the clamp 30 is hooked and supported by a hook section 42 to be described below.

A frictional member 38 is provided on the bottom surface of the clamp 30 at a position corresponding to the edge of a central through-hole of the disk D. A position at which the frictional member 38 is installed on the bottom surface of the clamp 30 is a circumferential edge of the bottom surface of the clamp 30. The frictional member 38 substantially has the shape of a ring and a long rectangular cross section. The frictional member 38 prevents the disk D from sliding between the clamp 30 and the turntable 24. However, it is not essential for the frictional member 38 to have the ring shape, but it may be intermittently disposed along a circular locus.

A cabinet 40 is to form an external appearance of the disk drive, and is provided with the hook section 42 on one side thereof. The hook section 42 is constructed by concavely forming one side of the cabinet 40. A clamp through-hole 43, through which the clamp 30 is penetrated, is formed at the center of the hook section 42. The clamp through-hole 43 has a diameter that is larger than that of the lower end of the clamp 30 and smaller than that of the upper end of the clamp 30 at which the hook wing 36 is located.

Therefore, the hook wing 36 is hooked on a bottom surface of the hook section 42, which corresponds to an edge of the clamp through-hole 43, so that the hook wing 36 can be supported on the hook section 42. In the illustrated embodiment, the hook section 42 is integrally formed to the cabinet 40, but it may be separately prepared and attached. A reference numeral 42′ indicates an isolation plate, which isolates the inside of the heating furnace 42 from the outside.

An operation of the disk clamping apparatus for a disk drive having the above-described construction according to the present invention will be described.

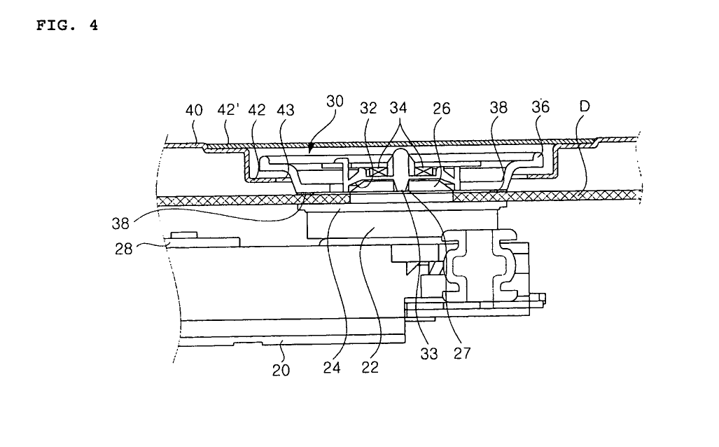

During operation where the disk D is loaded into the disk drive by a tray, the pickup base 20 is relatively lowered at its front end. Therefore, the pickup base 20 does not collide with the turntable 24, etc. when the disk D moves. This state is illustrated in FIG. 4.

However, at the last stage of the loading operation, the pickup base 20 is raised, and thereby the disk D is seated on the turntable 24. That is, the central through-hole of the disk D is inserted around the insertion cone 26 of the turntable 24. Simultaneously, the clamp 30 is coupled to the turntable 24 and fixes the disk D to the turntable 24.

Finally, in a state where the disk D is fixed to the turntable 24 by the clamp 30, as illustrated in FIG. 4, the hook wing 36 of the clamp 30 is no longer supported on the hook section 42. Hence, the clamp 30 can integrally rotate with the turntable 24 and the disk D without interference with the hook section 42.

At this time, the frictional member 38 surrounding the edge of the bottom surface of the clamp 30 is brought into close contact with the top surface of the disk D seated on the turntable 24, thereby preventing the disk D from sliding on the clamp 30. In this manner, when the frictional member 38 of the clamp 30 presses the disk D, the disk D does not arbitrarily slide on the turntable 24. This is because the clamp 30 is coupled to the turntable 24.

As described above, in the state where the disk D rotates together with the turntable 24, the optical pickup 28 moves in a radial direction of the disk D. In the meantime, the optical pickup 28 irradiates a signal recording surface of the disk D to record or reproduce a signal.

Meanwhile, in the present invention, the turntable 24, the disk D and the clamp 30 are adapted to integrally rotate. In this case, the clamp 30 is coupled to the turntable 24 by magnetic force of the magnet 34, and simultaneously the frictional member 38 located on the bottom surface of the clamp 30 presses the disk D, so that the disk D is prevented from rotating relative to the clamp 30 and the turntable 24. Here, the frictional member 38 increases frictional force between the clamp 30 and the disk D, thereby preventing relative movement between them.

As described above in detail, the disk clamping apparatus for a disk drive according to the present invention can obtain the following effects.

First, the frictional member is provided on the bottom surface of the clamp, and the disk is fixed to the turntable, so that the clamp, the disk and the turntable are allowed to integrally rotate. Thus, the vertical distance between the top surface of the turntable, i.e. the signal recording surface of the disk and the optical pickup is more accurately managed, so that the operational characteristic of the disk drive is improved.

Further, because the frictional member is provided on the bottom surface of the clamp, even when the disk contacts the clamp in the process of loading and unloading, the frictional member is brought into contact with the disk, thereby preventing a scratch from being generated from the disk. Thus, the damage to the disk is prevented in advance.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A disk clamping apparatus for a disk drive, comprising:
a turntable that is driven by a spindle motor provided on a pickup base and on which a disk is seated;
a clamp coupled with the turntable to fix the disk to the turntable with the disk seated on the turntable; and
a frictional member causing the turntable, the clamp and the disk to integrally rotate, and closely contacted on a disk surface opposite to the spindle motor on the basis of the disk.

2. The disk clamping apparatus as claimed in claim 1, wherein the frictional member is provided on a bottom surface of the clamp and selectively brought into close contact with a top surface of the disk.

3. The disk clamping apparatus as claimed in claim 1, wherein the frictional member is provided on a circumferential edge of a bottom surface of the clamp.

4. The disk clamping apparatus as claimed in claim 1, wherein the frictional member has a long rectangular cross section.

5. The apparatus as claimed in claim 1, wherein the frictional member is intermittently disposed on a bottom surface of the clamp so as to have a circular locus.

6. A disk clamping apparatus for a disk drive, comprising:
a turntable that is driven by a spindle motor provided on a pickup base, from the center of which an insertion cone protrudes, and on which a disk is seated;
a clamp coupled with the turntable by magnetic force or self-weight and fixing the disk to the turntable in a state where the disk is inserted around the insertion cone and seated on the turntable; and
a frictional member provided between the clamp and the disk, brought into close contact with the disk by the clamp, and preventing relative movement between the clamp and the disk.

7. The disk clamping apparatus as claimed in claim 6, wherein the frictional member is provided on a bottom surface of the clamp and selectively brought into close contact with a top surface of the disk.

8. The disk clamping apparatus as claimed in claim 7, wherein the frictional member has a long rectangular cross section.

9. The disk clamping apparatus as claimed in claim 7, wherein the frictional member is intermittently disposed on a bottom surface of the clamp so as to have a circular locus.
